(19) United States
(12) Patent Application Publication
(10) Pub. No.: US 2013/0334146 A1
(43) Pub. Date: Dec. 19, 2013

(54) Granular Chemical Feeder

(71) Applicant: Hillary Jean Raffin, South St. Paul, MN (US)

(72) Inventor: Hillary Jean Raffin, South St. Paul, MN (US)

(21) Appl. No.: 13/525,291

(22) Filed: Jun. 16, 2012

(51) Int. Cl. E03C 1/046; C02F 1/68

(52) U.S. Cl. 210/749; 137/268

(57) ABSTRACT

A granular chemical feeder installed off-line, to a pool or large aquarium circulation system. The feeder may be attached via tubing or by using hard plumbing. The feeder body inlet tubing includes a manual ball valve, inlet strainer, and a solenoid that will connect to a level switch within the feeder body. The outlet tubing includes a minimum of an outlet ball valve. Within the feeder body the chemical may be added from above. Over the water flow is a sifter assembly with blades on the upper and lower portions of the mesh or grating. When the feeder is in operation, a motor will turn a shaft connected to the blades of the sifter. The upper blades will sift the granular chemical into the moving water below and through the outlet tubing as it is transported into circulation by the water.

### FIELD OF THE INVENTION

The present invention relates to addition of granular chemical to bodies of water, such as pools, spas, and aquariums, with a circulation system or controlled flow of water.

### BACKGROUND OF THE INVENTION

To maintain the correct water quality condition for the particular application, granular chemicals are often added to a body of water. There are two main methods typically used to do this. The most common route is simply to measure out the chemical required and then manually add it to the body of water. Although relatively simple to implement, manual chemical addition can create multiple problems.

In pools a manual addition of chemical requires the pool operator to close the body of water to patrons to prevent anyone coming in contact with the raw chemical that has yet to dissolve. These “hot spots” take varying lengths of time to dissolve based on factors such as temperature of the water, amount of chemical added, and the turnover rate of the system. Current NSPF (National Swimming Pool Foundation) regulations state a pool must be closed for a minimum of one hour to patrons after a manual addition is made. Spas require a minimum of thirty minutes closed to patrons. This closure protects patrons from getting a reaction from contacting high local concentrations of raw chemical. Tablet feeders, liquid feeders, and slurry feeders all have the capability to add their chemical gradually thus allowing the body of water to remain open during their operation. For hotels, athletic clubs, schools this length of time the water sits unusable is typically unacceptable. Manual additions also require the chemical to be carried into the pool room which can spill and leaves damage causing residues on the floor around the pool shell. Large batch dosages of chemical can also create cloudiness as the water balance shifts. This cloudiness can prolong the amount of time a body of water is closed as a pool or spa cannot be open if the main drain is not visible. In aquariums a medium or large dosage of chemical can be hazardous to the inhabitants. Many fish for example cannot survive extreme changes in water balance at a rapid rate thus forcing the person changing the water to have to do gradual changes. They may need to add a cup of chemical every thirty minutes for four hours, They may need to introduce the animals in stages using multiple tanks, gradually increasing the amount of chemical with each tank for a set amount of time. Both of these methods can be very time consuming.

Another typical way granular chemical is added is by using a “slurry” mix. The granular chemical is mixed in a container with water either manually or mechanically, creating the slurry mix. Tubing is placed into the slurry and connected to a peristaltic pump. The pump will then transport the slurry mix through the tubing and the pump to an injection fitting and then into the circulation system. One of the largest issues with a slurry mix is the lines becoming clogged. If not continually in operation the slurry can harden or crystallize in the tubing causing the tubing to either require cleaning or replacement. Clogging can also occur in the injection fitting. If air gets into the tubing it can cause the lines to need to be primed to force it to start pulling slurry again. Also in the container itself the slurry typically sits in its container where it can start to harden as well.

### SUMMARY OF INVENTION

The disclosure describes devices and methods for the introduction of granular chemical dosing without the need to close a body of water to patrons, nor the messy task of a slurry feed. As the chemical is added dry and all mixing and dispensing is completed in closed tanks and piping systems, it allows the chemical to stay away from pool decks and other locations where others can come in contact with the body of water. With the adjustable speed device and even a timer you can fully automate when your chemical is getting added and at what speed. Allowing a granular chemical to be added at a gradual rate will allow a more efficient control of the water and its balance.

The granular chemical management system includes a canister shaped granular chemical feeder with inlet and outlet piping for connecting the chemical feeder, or canister, to the body of water, or other liquid's circulation system. The chemical feeder includes a mesh platform inside the canister for a granular chemical to be placed upon. A removable, sealable lid to allow the chemical feeder to be airtight when in operation.

The system piping includes manually or automatically controlled valves on the inlet and outlet plumbing of the chemical feeder, to isolate the chemical feeder for cleaning or maintenance. A motorized assembly is used to keep the mesh platform from clogging, and for granular chemical distribution. A solenoid or other electrical valve is used to control water flow entering into the feeder. The motorized assembly may include an adjustable speed device connected, which may be connected electrically to the solenoid valve, which controls the speed of chemical addition.

A granular chemical management system may also include a timer or other electronic device to set a chemical feeding schedule. A booster pump and check valve assembly may be connected to the plumbing to further ensure no flooding of the feeder may occur if the main circulation pump, of the body of liquid's circulation system, shuts down unexpectedly or in the case of installations where the chemical feeder is lower than the body of water, or below grade.

### LISTING OF FIGURES

FIG. 1 provides a perspective view of the granular chemical management system.

FIG. 2 provides a bottom view of the cover.

FIG. 3 provides a cross-sectional view of the chemical feeder.

FIG. 4 provides a view of the sifter assembly.

FIGS. SA-5D provides a schematic of the granular chemical management system during use.

### DETAILED DESCRIPTION OF THE INVENTION

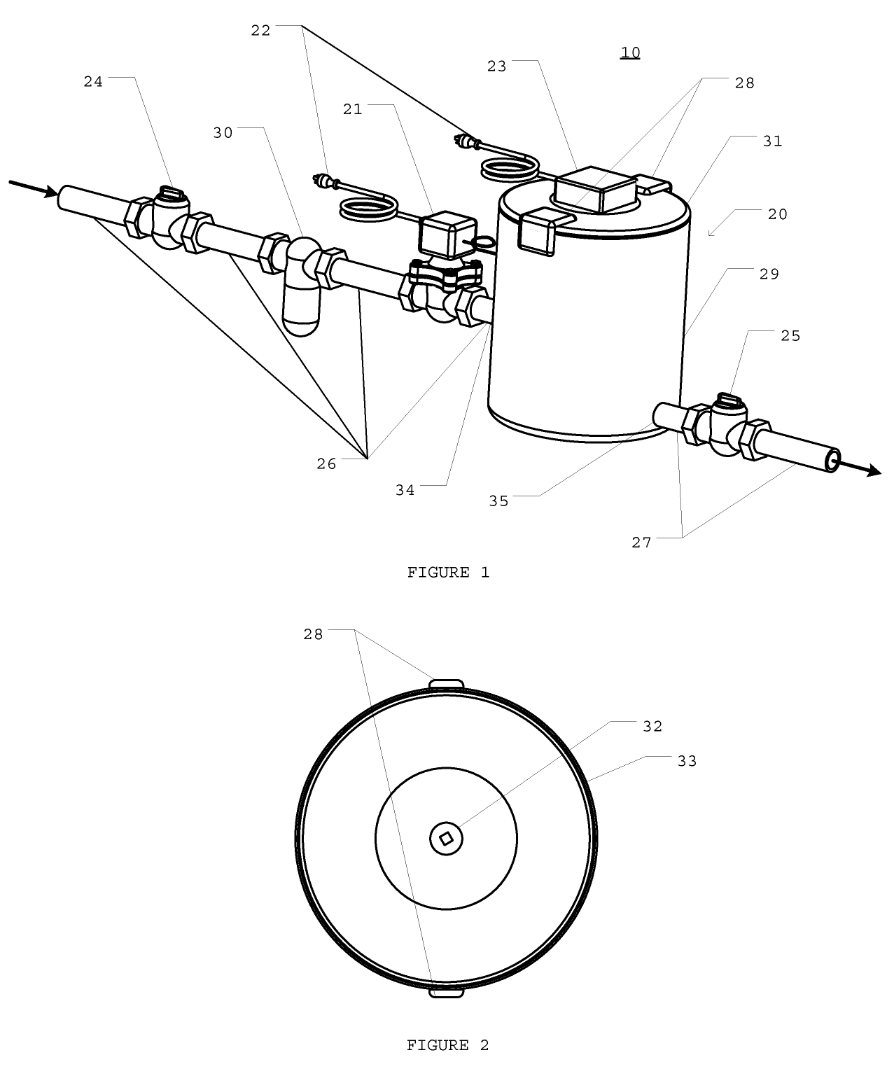

The disclosure directed towards a granular chemical management system 10 generally including an installed chemical feeder 20 to the main circulation system of a pool, spa or large aquarium as shown in FIGS. 1-5D. A main circulation system may be used to filter, adjust temperature, replace water lost through evaporation and provide chemical addition. The granular chemical management system 10 may be installed to treat all or a portion of the flow through the main circulation system. The granular chemical management system 10 includes a canister shaped granular chemical feeder 20 with inlet and outlet piping for connecting the chemical feeder 20, or canister, to the body of water, or other liquid's circulation system. As shown in FIG. 1 the chemical feeder includes a mesh platform inside the canister for a granular chemical to be placed upon. A removable, sealable lid 31 allows the chemical feeder 20 to be airtight when in operation.

Typically granular chemical management system 10 will be installed with the inlet tubing, or influent tubing, drawing water post circulation pump and post filter if one exists. This will ensure a strong flow rate into the chemical feeder 20. The influent can be connected to the main circulation system via hard plumbing or a hose barb may be added at the end of the influent side of the chemical feeder 20 so flex tubing with a hose clamp can be used instead. The outlet tubing 27, or effluent side of the chemical feeder 20, may be connected in a similar fashion in regard to hard plumbing versus flex tubing. The influent and effluent tubing of the chemical feeder 20 itself is preferably be rigidly plumbed and may include a P-trap between the feeder body and the manual ball valve. The inlet tubing 26 is preferably a minimum of ¾ inch equal. The outlet tubing 27 is preferably a minimum of ¾ inch and at least equal or larger than inlet tubing, The effluent side is recommended to be installed before the main circulation pump. This will aid in evacuating the chemical feeder 20 at a fast rate and aid in preventing the chemical feeder 20 from flooding. The granular chemical management system 10 may include a booster pump if necessary for the operating conditions at a specific installation.

The granular chemical particles will not be at a consistency where it would be able to cause clogging of the chemical feeder 20. The effluent side may also be plumbed into the circulation system right before the water returns into the main body. If this style is used it is crucial to ensure there is enough of a drop in pressure on the main line between the chemical feeder's 20 influent and effluent installation points so the feeder will continue to evacuate correctly. Optionally, a booster pump may be included either on the influent or effluent side of the chemical feeder 20. A check valve may also be installed on below grade installations to prevent backflow in the case of loss of prime by the main circulation pump. The hard tubing of the feeder will be firmly attached on influent and effluent lines so they enter the feeder body 29 by approximately one inch. This will ensure the smooth transport of water into the main feeder body 29.

There preferably will be a manual ball valve at the very end of both the influent and effluent sides of the feeder piping. These valves allow the feeder to be isolated from water flow for maintenance, cleaning, or refilling. When closing the feeder one should close the inlet valve 24 first then the outlet valve 25, the reverse procedure should be used when reopening the valves.

As water begins its course through the influent side it will go through the aforementioned ball valve then it will go through an inlet strainer 30. This strainer 30 should be able to have its cover removed for easy cleaning when the feeder ball valves are closed. The strainer is in place to keep debris in the water from entering the feeder itself and clogging the solenoid valve 21 or internal components.

After the water goes through the inlet strainer 30 it will pass through a solenoid valve 21 and enter the feeder. The solenoid valve 21 will be connected with a level switch 36. A float assembly may be used in its place keeping in mind that due to the gpm, or gallons per minute, of water being pushed through the chemical feeder 20 by the main circulation pump plus any extra speed from gravity is the chemical feeder 20 is below grade, a float switch in this style application may not be strong enough to close properly and may not be able to close the influent line when the float calls for it. The solenoid valve 21∝s level switch 36 will be attached inside the feeder just above the top lip of the influent tubing inside the feeder by a minimum of one inch. If the water level reaches the level switch the solenoid valve 21 will close preventing more water from entering the feeder body until the water level inside has dropped. When the water level has not reached this point the solenoid valve 21 will be open allowing water in through the influent line, The solenoid valve 21 will have a standard power cord 22 to be plugged into live power. In the case of a float assembly or float switch being used rather than a solenoid valve 21 it will be located within the feeder body 29 itself and be connected on the inlet tubing 26.

Once the water enters to feeder it falls into the base of the chemical feeder 20, filling the feeder base until the water level reaches the outlet fitting 35. The outlet fitting 35 should be a minimum of two inches from the very bottom of the feeder body 29 and its top lip should be a minimum of once inch below the bottom lip of the inlet fitting 34.

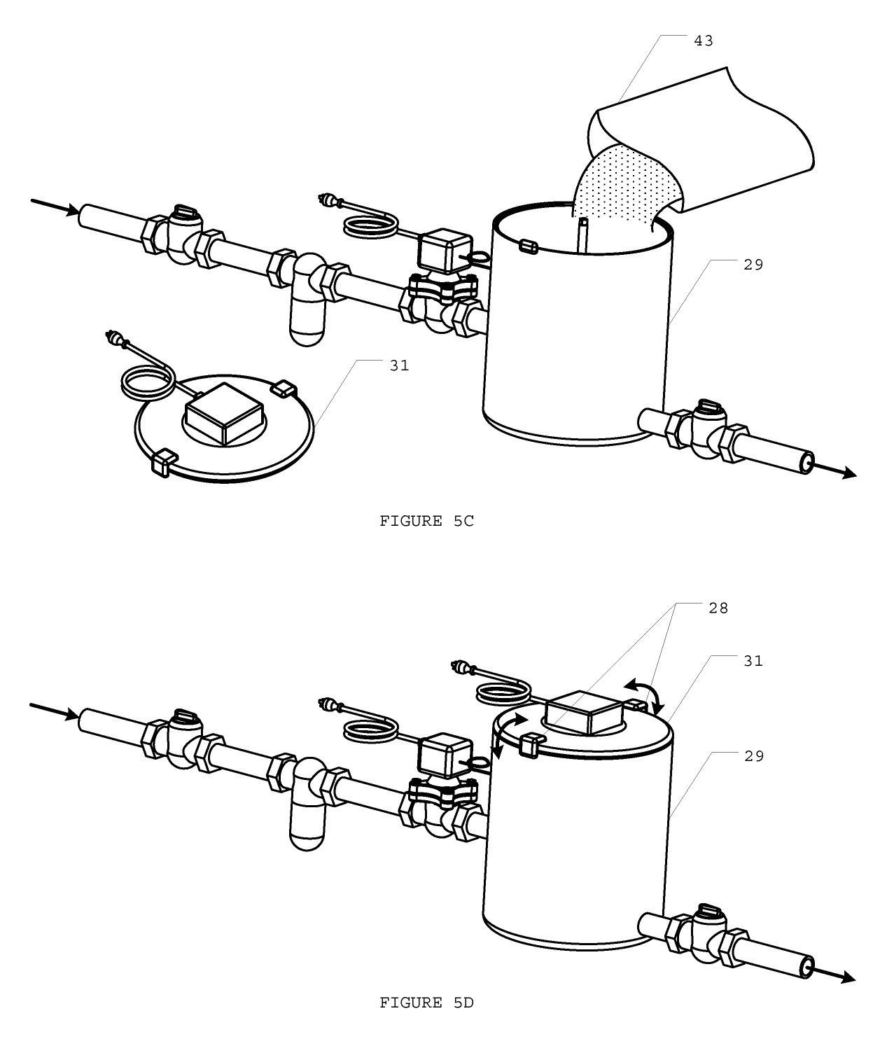

A minimum of one inch above the inlet fitting 34 within the feeder will sit a sifter assembly 50. The sifter assembly 50 as well as other components of the chemical feeder 20 are preferably manufactured of materials that are compatible with high moisture conditions and the chemicals being used. These include plastics, fiberglass and corrosion resistant or coated metals. The sifter assembly 50 includes a plurality of blades 40, 41 rotating around a shaft 38 on the upper and lower surfaces of a mesh screen 39 (See FIG. 4). The mesh screen 29 is held in place by a minimum of four shelf clamps 37, and may have fasteners 43 protruding upward from the shelf clamps 37. The shelf clamps 37 may be molded to the feeder body 29 itself or attached the feeder body 29, and preferably are equidistant from each other along the feeder's circumference. The screen 29 shall have a properly spaced hole for attachment to each shelf clamp 37. The screen 29 may then be placed onto the screws and tightened in place with the fasteners 43 which may include a washer and nut 42 for every bolt. This will hold the screen 29 in place during operation and also allow its removal as needed. Other embodiments of the fastener 43 include pins or tabs to engage the screen 39 and prevent its rotation. The screen 39 shall have openings sufficiently sized to allow passage of the chemical granules as they are agitated by the rotating upper blades 40. The sifter assembly 50 will also have lower blades 41 on the underside of the very bottom screen along with its normal blade assembly on the upper surface. The lower blades 41 will prevent caking on the bottom of the screen due to the moisture rich environment. The blades 40, 41 preferably will extend out so they have a radius slightly less than the feeder body 29 so they clear the shelf clamps 37 and the fasteners 41 as the blades 40, 41 rotate.

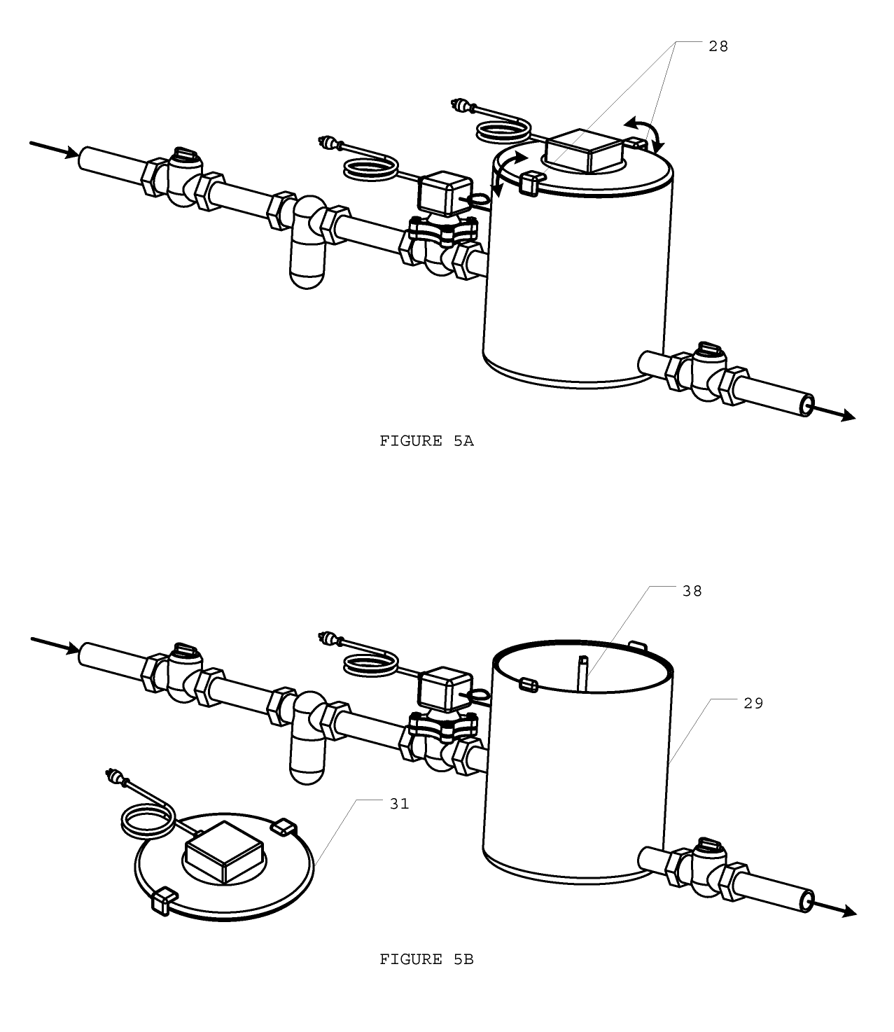

A shaft 38 connected to the blades 40 in the center of the sifter assembly 50 (See FIG. 3). This shaft 38 runs through a lid opening 32 in the center of the lid 31 and locks into a motor 23 with an adjustable speed device. The screen 39 sits between the upper and lower blades 40, 41 but cannot be attached to them or the shaft in order to allow the sifter to rotate correctly. If the washer and nuts 42 are removed from each shelf clamp 37 the entire sifter assembly 50, upper blades 40, lower blades 41, and screen 39 can be removed as one component and easily pulled out by lifting up the shaft 38 they are attached to. The granular chemical will sit on the top of the screen 39 until use.

When in operation the motor 23 with an adjustable speed device on the top of the lid will turn the shaft which in turn moves the blades in a circular fashion over the screen pushing product through it and into the running water below. This adjustable speed device and its motor 23 are a part of the lid and will disconnect from the shaft 38 in the feeder if the lid 31 is removed. The adjustable speed device can also be used in conjunction with a timer or automated controller to fully automate the feeder.

Once the chemical has been dropped into the running water by the sifter assembly 20 it will begin to mix and dissolve while exiting the effluent piping. This water shall run through the p-trap and manual ball valve, through the feeder's effluent installation point and into the main circulation system.

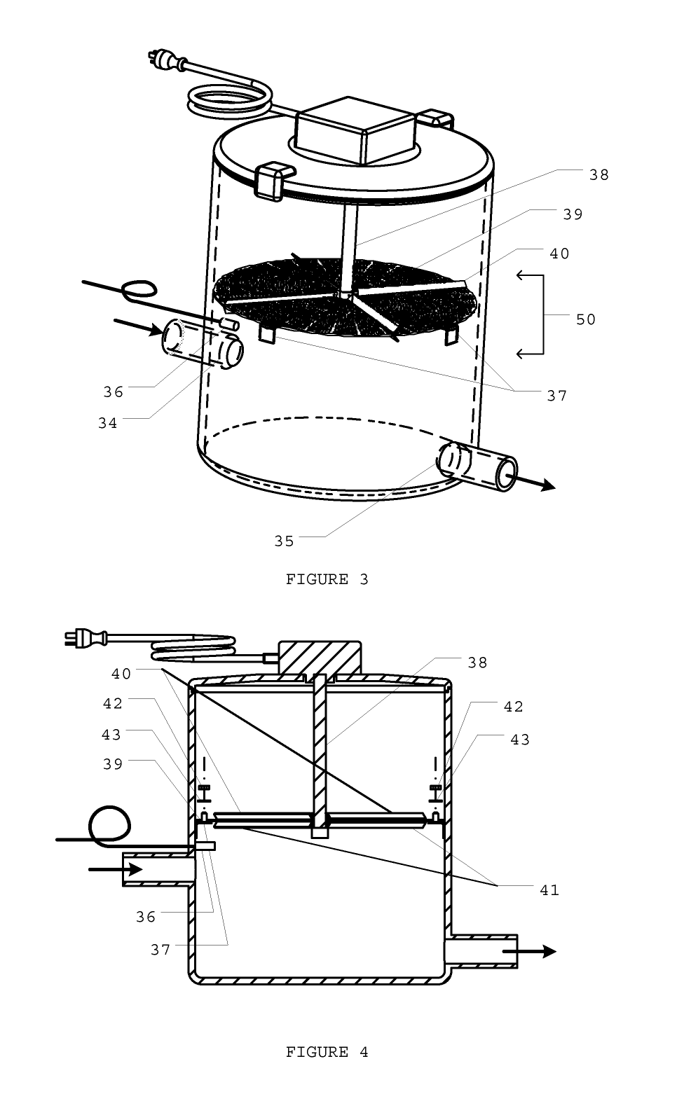

The feeder body 39 shall include lid clamps 28 so that the lid 31 of the feeder should be clamped down in a minimum of two locations. As shown in FIG. 2, the lid 31 shall have an O-ring 33 that fits around the entire lip of the feeder body so when the lid 31 is clamped down a complete seal is formed.

The feeder body itself should sit on a stand with a height a minimum of six inches off the floor. This is to aid in preventing uphill runs from the main circulation system to the effluent side of the feeder. This in conjunction with the p-trap will create protection from backflow.

As shown in FIGS. 5A-D, when filling the feeder one should unplug the feeder or turn off the timer to remove power to its motor 23 and then remove the motor and the variable speed drive. Then simply unclamp the lid 31 and pull it off the shaft. The shaft will extend slightly above the former position of the lid. The granular chemical feed can then be easily poured into the base of the chemical feeder 20 to sit upon the screen, and then the lid can be replaced and relocked with the lid clamps. If cleaning is needed you remove power and open the lid as aforementioned. After the lids removal you then remove the bolts and washer for each shelf support and then remove the sifter assembly by pulling the shaft upwards.

What is claimed is:

1. A granular chemical management system for mechanically adding granular chemical to a body of water with a circulation system, comprising:
a. a chemical feeder having a feeder body with a lid to seal the chemical feeder;
b. the feeder body having an inlet fitting and an outlet fitting;
c. the feeder body substantially containing a sifter assembly;
d. the sifter assembly having a shaft for rotating a plurality of blades adjacent to a screen for holding granular chemical;
e. a motor for turning the shaft to move the granular chemicals through the screen.

2. The system according to claim 1, further comprising: an inlet valve and an outlet valve to isolate the chemical feeder for cleaning or maintenance.

3. The system according to claim 1, further comprising: a solenoid valve to automatically stop flow to the chemical feeder.

4. The system according to claim 1 wherein the motor speed is variable to automatically adjust a chemical dose rate.

5. The system according to claim 1, further comprising: a booster pump to increase inlet pressure.

6. The system according to claim 1, further comprising: a timer connected to the system to automatically turn the system on and off on a predetermined schedule.

7. The system according to claim 1, further comprising: a check valve assembly connected to the system, to protect the system during service interruptions in the case of installations where the chemical feeder is lower than the body of water, or below grade.

8. The system according to claim 1, further comprising: the feeder body having a lid cover with an O-ring to substantially seal the system against pressure leakage.

9. The system according to claim 1, further comprising: an inlet valve and an outlet valve to isolate the chemical feeder for cleaning or maintenance.

10. The system according to claim 1, further comprising: the sifter assembly having a mesh screen and a plurality of upper blades to move the granular chemicals through the mesh screen.

11. The system according to claim 1, further comprising: the sifter assembly having a mesh screen and a plurality of lower blades to clean the mesh screen.

12. A method of adding a granular chemical to a body of water comprising the steps of:
a. unlocking and removing a lid;
b. pouring a granular chemical directly into a feeder body;
c. supporting the chemical within the feeder body above a mesh screen;
d. replacing and relocking the lid;
e. removing a portion of water from a body of water;
f. directing a flow of water to the feeder body;
g. rotating at least portions of a sifter assembly to move the granular chemical through the mesh screen and into the portion of water;
h. directing the portion of water back to the body of water.
